(19) United States
(12) Patent Application Publication
(10) Pub. No.: US 2020/0357157 A1
(43) Pub. Date: Nov. 12, 2020

(54) A METHOD OF GENERATING TRAINING DATA

(71) Applicant: CUBIC MOTION LIMITED, Manchester (GB)

(72) Inventors: Gareth Edwards, Macclesfield (GB); Jane Haslam, Marlow (GB); Steven Caulkin, Altrincham (GB)

(21) Appl. No.: 16/764,543

(22) PCT Filed: Nov. 15, 2018
(86) PCT No.: PCT/GB2018/053317

§ 371 Date: May 15, 2020

(30) Foreign Application Priority Data
Nov. 15, 2017 (GB) 1718895.4

(51) Int. Cl. G06T 13/40; G06T 7/50; G06T 19/20; G06K 9/00; G06K 9/62

(52) U.S. Cl. CPC G06T 13/40; G06T 7/50; G06T 19/20; G06K 9/00281; G06K 9/6256; G06T 2219/2016; G06T 2219/2021; G06T 2207/20084; G06T 2207/30201; G06T 2219/2004; G06T 2207/20081

(57) ABSTRACT

The present invention relates to method of generating training data for use in animating an animated object corresponding to a deformable object. The method comprises accessing a 3D model of the deformable object, defining a plurality of virtual cameras directed at the 3D model; varying adjustable controls of the 3D model to create a set of deformations on the 3D model. Then, for each deformation, capturing 2D projections of points at each virtual camera, combining the projections to form a vector of 2D point coordinates, generating a vector of 2D shape parameters from the point coordinates, and combining the shape parameters with the values of the adjustable controls for that deformation to form a training data item. The training data items are combined to form a training data set for use in training a learning algorithm for use in animating an animated object corresponding to the deformable object based on real deformations. The method allows for the generation of large quantities of training data that would otherwise be very time-consuming to obtain from the deformable object.

This invention relates to a method of generating training data. In particular, it relates to a method of generating training data for use in animating an animated object corresponding to a deformable object.

### BACKGROUND

The use of computer-generated characters or other objects in entertainment media is becoming increasingly popular. In many cases, the computer-generated characters may be animated based on the actions of a real actors or objects, where for example the facial expressions of an actor may be recorded and used as the basis for the facial expressions displayed in the animation of the digital character. The original recordings of the actor may be labelled and paired with the corresponding values of the animated character. This paired labelled actor data and corresponding character data is referred to as training data. The training data is used to train a learning algorithm. Then, when it is desired to create footage of the animated character, which may be referred to as the runtime phase or simply runtime, the actor performs the desired role, and his or her facial expressions are captured. The trained learning algorithm analyses the captured expressions and generates the corresponding animated features of the character.

The step of animating comprises determining a value of one, or more commonly many, control values at each of a plurality of points in time, such as for each frame of an animation. Each control value relates to an aspect of an animation. Where the animation is of a character then a control value may relate to, for example, movement of features of interest such as the character's eyeball or more complex movements such as “smile”. The value of a control may be predicted based on geometric information extracted from video data of an actor i.e. the training data. The geometric information is typically based upon a location of one or more fiducial points in the video data.

Predicted control values for the features of interest are calculated using a trained learning algorithm, such as a feed forward artificial neural network (ANN) or other non-linear learning algorithms such as Support Vector Machines or Random Forest Regression. In the runtime phase, the predicted control values may then be applied to a digital character to automatically animate the digital character in real-time or stored for later use in animating a digital character.

Training data should be selected to represent the typical variation which the system is expected to learn, for example frames including a range of eye movement to be replicated in an eye of a digital character. The selected training frames have a list of target control values that relate to an attribute or feature of the animated character for each image.

Based on the training data, the system must learn a functional relationship, G, between a vector, b, of target control values and the values in a vector, S, of values derived from geometric measurements corresponding to a training frame with those target control values, such that:

b=G(S)

Typically, the vector S may be vector of shape parameters derived from point data, for example using Principal Components Analysis to calculate a vector of eigenvalues. Function G may be expected to be a complicated and non-linear vector function.

In all cases, such learning algorithms are reliant on the quality and quantity of training data used to train the algorithm. Typically, all training data must be selected by a human operator and appropriate character control values provided and therefore it can be difficult to provide a large amount of training data to successfully train an ANN, or other non-linear prediction system. Particular problems arising from the selection of insufficient training data include overfitting and lack of robustness.

Input data, in the form of the sample vector, S, can be high-dimensional, including a large number of geometric measurements. Any non-linear system trained on just a few tens of examples at most—but with a high (e.g. greater than 5) number of dimensions in the input data would be expected to fail due to ‘overfitting’; with so many dimensions, fitting the training data becomes easy, but generalization to unseen data is almost impossible.

It is an object of embodiments of the invention to at least mitigate one or more of the problems of the prior art.

### BRIEF SUMMARY OF THE DISCLOSURE

In accordance with the present inventions there is provided a method of generating training data as defined in the accompanying claims.

According to an aspect of the invention there is provided a method of generating training data for use in animating an animated object corresponding to a deformable object, the method comprising accessing a 3D model of the deformable object, wherein the 3D model is annotated with a plurality of fiducial points, which fiducial points correspond to features of the deformable object and are subject to adjustable controls which change the representation of the 3D model; defining a plurality of virtual cameras, the cameras directed at the 3D model; varying the adjustable controls of the 3D model to create a set of deformations on the 3D model; for each deformation in the set of deformations, capturing 2D projections of at least some of the fiducial points at the virtual cameras, combining the 2D projections, using the combined 2D point coordinates to generate 2D shape parameters, and combining the 2D shape parameters with the corresponding values of the adjustable controls for that deformation to form a training data item. The method may further comprise combining the training data items to form a training data set suitable for use in training a learning algorithm for use in animating an animated object corresponding to the deformable object based on real deformations of the deformable object captured by cameras whose poses correspond to those of the plurality of virtual cameras.

According to an aspect of the invention there is provided a method of generating training data for use in animating an animated object corresponding to a deformable object, the method comprising accessing a 3D model of the deformable object, wherein the 3D model is annotated with a plurality of fiducial points, which fiducial points correspond to features of the deformable object and are subject to adjustable controls which change the representation of the 3D model; defining a plurality of virtual cameras in a model space, the cameras directed at the 3D model; varying the adjustable controls of the 3D model to create a set of deformations on the 3D model; for each deformation in the set of deformations, capturing 2D projections of the plurality of fiducial points at each virtual camera, combining the 2D projections from each camera to form a vector of 2D point coordinates, using the vector of 2D point coordinates to generate a vector of 2D shape parameters derived from the 2D point coordinates, and combining the 2D shape parameters with the corresponding values of the adjustable controls for that deformation to form a training data item; and combining the training data items to form a training data set suitable for use in training a learning algorithm for use in animating an animated object corresponding to the deformable object based on real deformations of the deformable object captured by cameras whose poses correspond to those of the plurality of virtual cameras.

Optionally, the method comprises perturbing the pose of at least one of the virtual cameras for each deformation and capturing the 2D projections for each perturbed pose.

Perturbing the orientation of the virtual camera may comprise altering the orientation by up to 20° in any direction. Perturbing the orientation of the virtual camera may comprise altering the orientation by up to 10° in any direction.

Perturbing the location of the virtual camera comprises altering the location by up to 0.03 m in any direction. Perturbing the location of the virtual camera comprises altering the location by up to 0.025 m in any direction.

Optionally, the method may comprise aligning the 2D projections for each deformation. Aligning the 2D projections for each deformation may comprise using at least one of a translation or rotational alignment.

Varying the adjustable controls of the 3D model may comprise varying the adjustable controls to each of a set of predefined values. Varying the adjustable controls of the 3D model may comprise varying the adjustable controls in a stepwise manner.

Optionally, the deformable object is a face and the deformations correspond to facial expressions. The fiducial points may correspond to natural facial features. The fiducial points may comprise points marked on the actor's face.

Combining the 2D projections from each camera to form a vector of 2D point coordinates may comprise concatenating the 2D projections from each camera.

Training the learning algorithm using the training data set may comprise building a prediction model between 2D shape parameters and the known values of the adjustable controls.

Building a prediction model may comprise using a support vector machine, using a neural network and/or other suitable machine learning tools.

Optionally, the method may comprise using the learning algorithm to animate an animated object corresponding to the deformable object based on real deformations of the deformable object captured by cameras whose poses correspond to those of the plurality of virtual cameras.

According to an aspect of the invention there is provided a method comprising accessing a 3D model of a deformable object, wherein the 3D model is annotated with a plurality of fiducial points, which fiducial points correspond to features of the deformable object and are subject to adjustable controls which change the representation of the 3D model; defining a plurality of virtual cameras in the model space, the cameras directed at the 3D model; varying the adjustable controls of the 3D model to create a set of deformations on the 3D model; for each deformation in the set of deformations, capturing 2D projections of at least some of the fiducial points at the virtual cameras, combining the 2D projections, using the combined 2D point coordinates to generate 2D shape parameters, and combining the 2D shape parameters with corresponding adjustable controls for that deformation to form training data.

### BRIEF DESCRIPTION OF THE DRAWINGS

Embodiments of the invention are further described hereinafter with reference to the accompanying drawings, in which:

FIG. 1(a) is a flowchart for the training phase of a prior art digital animation based on a real object;

FIG. 1(b) is a flowchart of the runtime phase of a prior art digital animation based on a real object;

FIG. 2 is a diagrammatic representation of a model space in which a method according to the disclosure;

FIG. 3 is a flowchart of a method according to the disclosure;

FIG. 4 is a flowchart of an alternative method according to the disclosure; and

FIGS. 5(a), (b), (c) and (d) are examples of the model space of FIG. 1.

### DETAILED DESCRIPTION

This invention relates to a method of generating training data. In particular, it relates to a method of generating training data for use in animating an animated digital object, such as a digital computer character, corresponding to a deformable object in the real world, such as a human face.

The invention allows the creation of large quantities of synthetic training data for use in training a learning algorithm to animate an output object or character based on the input of a real object or person. The synthetic training data is automatically generated as part of the method. The burden of capturing sufficient training data from a person or object to be used as an input for an animation is greatly reduced as they are only required to facilitate the generation of a 3D rig at the start of the process.

Such training data may be used in developing a learning algorithm for use in character animation whereby a character is animated to have movement corresponding to that of an actor. The learning algorithm may allow animation based on the real-time movements of the actor.

Providing a suitable training data set allows a learning algorithm to be taught to discriminate between genuine changes in the signal of interest and change due to variation in position or orientation of camera used to capture the performance of the actor.

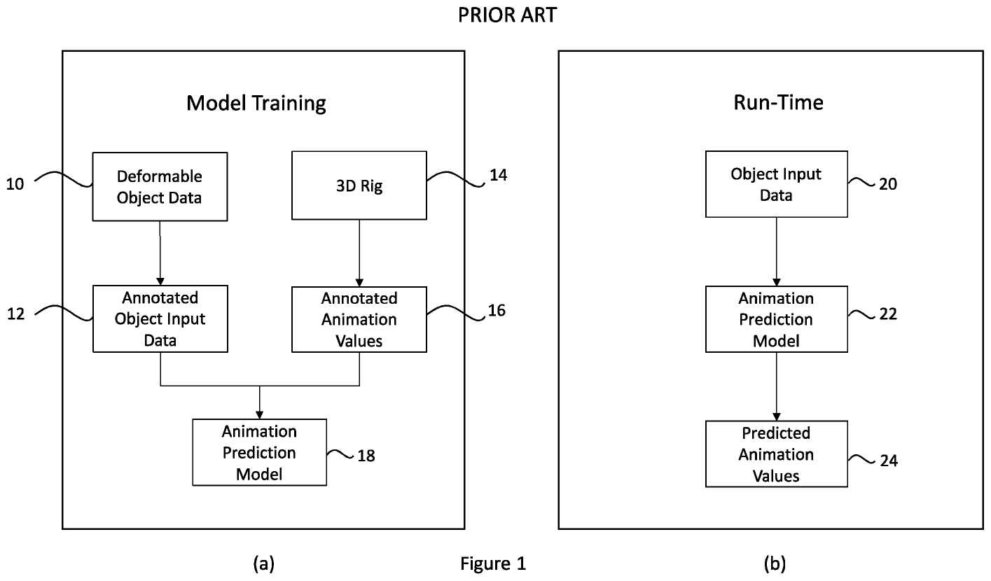

Referring initially to FIG. 1, there are shown flowcharts for a prior art implementation of digital animation based on a real object. FIG. 1(a) shows the training phase of such a process and FIG. 1(b) shows the runtime phase. Initially, in step 10, training data of the deformable object is gathered, typically, this may be video data. In step 12, this data is annotated manually to classify the different deformations or expressions displayed by the deformable object. In step 14, a 3D animateable model, also referred to as a rig, of the deformable object is created, based on the training data. In step 16, the control values for the 3D rig for deformations corresponding to the annotated training data are noted. In step 18, the annotated training data from step 12 and the control value data from step 16 are combined to generate an animation prediction model. Referring now to the Run-Time flowchart of FIG. 1(b), in step 20, input data of the object for use in the animation of the output animation is captured. This object input data may be referred to as performance data. The animated output is related to the deformable object but is not necessarily a direct representation thereof. In step 22, the performance data is processed according to the animation prediction model. Then in step 24 the predicted animation values according to the model are output. The deformable object and the 3D rig are existent prior to the training of the animation system. There are many extant systems and processes for creating 3D rigs; these systems and processes are not the subject of this patent application. In the training phase, the algorithm ‘learns’ how to relate 2-dimensional geometric measurements made in videos of a real actor to the desired animated motion of the 3D rig. The animated output is the generated in the runtime phase.

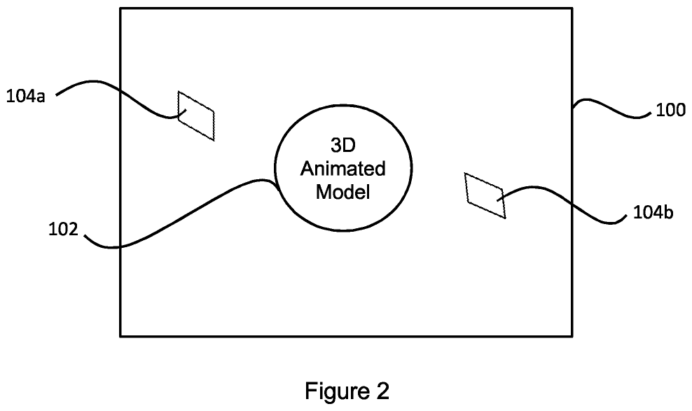

Referring now to FIG. 2, there is shown a diagrammatic representation of a virtual model space 100 wherein a method according to the disclosure may operate. The model space 100 comprises an animeatable 3D model 102 of a deformable object. Such an animeatable model may be referred to as a rig. In some examples, the deformable object is a human face. The model space may be provided as a digital asset in a 3D modelling software suite such as Maya® from Autodesk, Inc. or 3ds® Max from Autodesk, Inc.

The 3D model is annotated with a plurality of fiducial points (not shown). The fiducial points may correspond to user-defined targets or computer-defined targets on the deformable object. The rig includes a number of adjustable controls which allow the representation of the 3D model to be altered as the value of the adjustable control is altered. The value of the adjustable control may also be referred to as a control value. Typically, the variation in a control value will alter the position of one or more of the fiducial points. Where the deformable object is a face, the fiducial points may correspond to points on notable facial features, for example the outer corner of an eye or the outer corner of the mouth. In such the example of a mouth, changing the value of an adjustable control may change the position of the outer corner of the character's mouth.

The model space 100 further comprises two virtual cameras 104a and 104b directed at the 3D model 102. The virtual cameras 104 are preferably placed with a pose relative to the 3D model that will be replicated with real cameras with respect to the deformable object in a runtime phase. Here pose is understood to refer to the location and orientation of the virtual cameras in the model space with respect to the 3D model of the deformable object. It will be understood that the pose of a virtual camera is defined by its x, y, z position and its roll, yaw, pitch orientation. Modelling suites such as Maya® and 3ds® allow the definition of virtual cameras such as the virtual cameras 104a and 104b. The virtual cameras 104 may be configured with settings to mimic real life cameras such as focal length, lens distortion and image size. The virtual cameras 104 are adapted to capture a 2D projection of the fiducial points on the 3D model. While two virtual cameras 104 are shown here, it will be understood that three or more cameras may be defined in the model space and used to capture projections.

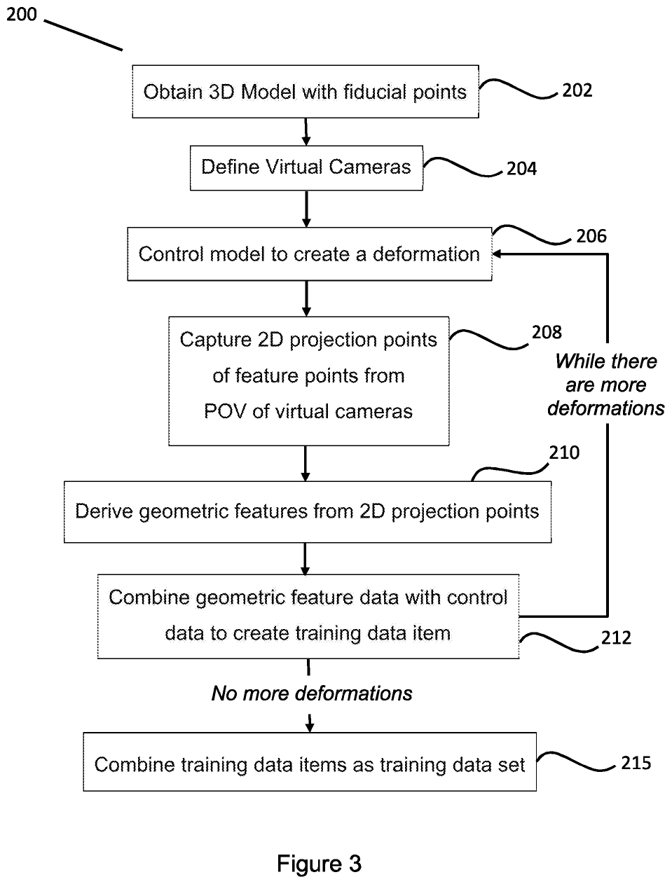

Referring now to FIG. 3, there is shown a flow chart of a method 200 according to the disclosure. In step 202, the 3D model 102 of the deformable object is obtained. The 3D model may be created as an initial step in the method, or it may be obtained from a third party. The 3D model 102 is annotated with a plurality of fiducial points. The fiducial points annotated on the 3D model 102 should correspond to the points that are going to be tracked on the deformable object, for example an actor's face, at runtime. The 3D model may be annotated manually, or automatically. If the actor is going to be wearing physical markers, for example make-up dots, then points on the 3D model should be chosen to correspond to the location of these dots. It will be understood that it is possible to use both marker-based and natural feature-based mark-up in the same setup. The feature points correspond to facial features such as key points on eyes, nose, lips etc. Each feature point may be animated, changing through a fixed range of positions, based on a control value. By adjusting a control value of the rig, the position of the feature points is changed thus altering the expression on the face of the 3D model. The control values can vary large parts, or even all of the rig. For example, it is possible to set a control value for “smile” wherein changing this value moves many of the fiducial points such that the rig of the face appears to be smiling.

In step 204, a pair of virtual cameras 104 are defined in the model space. In particular, their pose i.e. their position and angle relative to the 3D model are specified. The virtual cameras may be placed completely independently of each other, for example, there are no requirements as to any overlap in their field of view. The number of cameras that may be defined is not limited, and typical arrangements may include three or more virtual cameras. The pose of the virtual cameras in the model space should be as similar as possible to the intended pose of the cameras that will record the deformations of the deformable object at runtime.

In step 206, the values for the adjustable controls for the animateable 3D model are varied to create a set of deformations. For example, if the 3D model is of a human face, the control values of the 3D model 102 may be controlled to represent a set of facial expressions. The control values for a particular deformation or expression may be entered manually by a user or may be generated procedurally. In one example, sets of predefined control values are applied that have been chosen to represent specific expressions such as frown, smile, laugh etc. In another example, the control values are stepped through their whole or partial range. Alternatively, the deformations may be generated by a combination of predefined values for the adjustable controls and stepped variations thereto. Typically, several hundred deformations are generated in order to facilitate a good distribution of training examples covering the expected runtime behaviour of the deformable object. For example, for a talking performance with little expected in the extreme expression shapes, the training data will have more data for talking animation than overly expressive data.

In step 208, the virtual cameras capture 2D projected points corresponding to the fiducial points on the 3D model 102 for the current deformation. This functionality is provided by 3D modelling suites such as Maya® and 3ds®.

In step 210, the 2D projection points from all virtual cameras for the current deformation are combined to form a vector of 2D point locations that corresponds to the deformation created in step 206. The vector is formed by concatenating the vector of points from each virtual camera into a single vector. The concatenated vector then contains the information from all of the projected views.

The vector of 2D locations points may be aligned, for example such that the average position of the points is the origin (0,0), and the average distance of the points from the origin is unity, but this is not a requirement.

The vector of 2D point locations is then used to create a vector of shape parameters. The shape parameters may be any number of geometric features derived from the 2D point coordinates. These features are typically pre-defined as the raw or aligned fiducial point coordinates; “hand-crafted” parameters such as the curvature of a line joining a subset of points corresponding to a particular facial feature, for example lip curvature; or any other set of values derived from the geometry of the projected point coordinates.

In step 212, the generated vector of parameters for the current deformation is combined with the rig control values which were used to create the deformation and saved as a training data item. Steps 206 to 212 are then repeated with a different deformation or expression for each iteration until all of the desired deformations have been generated.

In step 215, the individual training data items are combined to form a training data set. In this way, a significant level of synthetic training data may be generated from the 3D model.

Once a sufficient level of training data has been generated, the training data is used to formulate prediction models between the control values used to create each expression on the 3D model and the shape parameters. There are a wide variety of known mathematical techniques for predicting the relationship between the shape parameters and the 3D model. Examples include neural networks, linear regression, support-vector regression and random-forest regression.

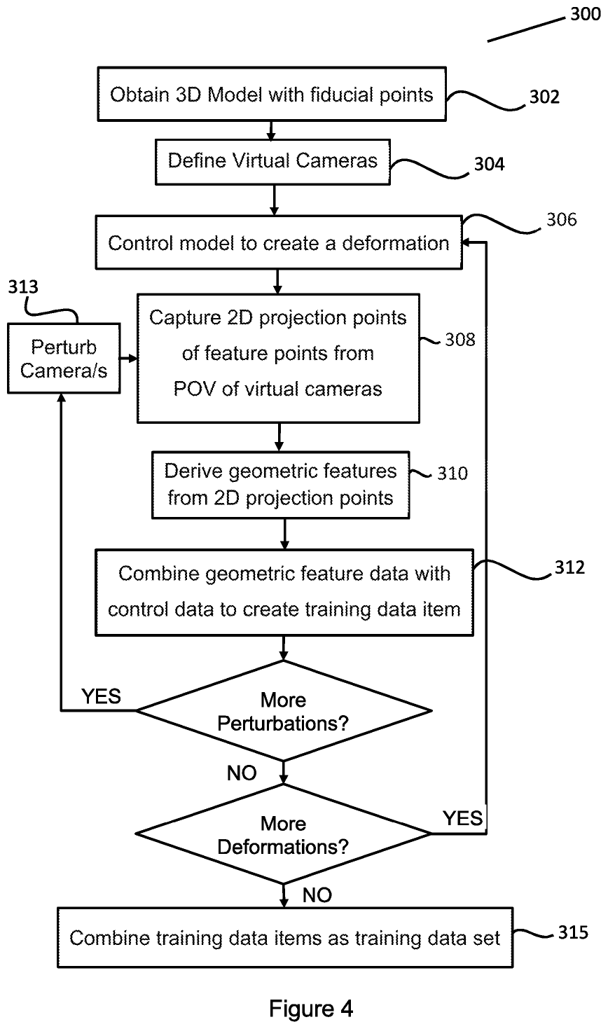

Referring now to FIG. 4, there is shown a flowchart of an alternative method 300 according to the disclosure. Steps 302 to 312 correspond to steps 202 to 212 of the method shown in FIG. 3 and will not be described again here. The method 300 of FIG. 4 differs from that of FIG. 3 in that the method 300 includes perturbing one or more of the virtual cameras. The pose of the any of the virtual cameras may be perturbed by altering its position and/or orientation. The position may be perturbed by changing one or more of the x, y or z coordinate of the camera's location. Typical perturbation sizes are up to ±0.03 m for x, y and z. The orientation may be perturbed by changing one or more of the pitch, roll and yaw angles of the camera's orientation. Any angle typically may be altered by up to ±10°. The perturbations may be generated according to a predefined set of perturbations; may be generated in a pseudo-random manner, or a combination of the above. In step 313, the method checks if there are more perturbations to be analysed for the current deformation control values. If the answer is yes, the method moves to step 315, where the next perturbation is applied to the virtual cameras. After step 315, the method returns to step 308 where the virtual cameras capture the 2D projections of the fiducial points on the 3D model. Once all of the desired perturbations of a deformation have been captured, the method 300 moves to step 314 where it checks if there are further deformations to be processed. If so, the method returns for step 206 and adjusts the control values to create the next desired deformation or expression. The values of the perturbations used may be saved to perform checks on the data or produce more data with a specific perturbation; these would usually be stored as variants on the original virtual cameras. However, this is only likely to be done if the perturbations aren't generated per each frame of data.

Each perturbation results in a slightly different vector of shape parameters. However, since the rig controls are not altered as the only change is to the camera positioning, the control values for each perturbation are the same. In this way, the perturbations aim to capture training data that is applicable if the real cameras at runtime are not positioned with exactly the same poses as the virtual cameras 104 during the training phase. The real cameras may be positioned incorrectly from set-up in the runtime phase, or they may move away from the correct positions during use in the runtime phase. These inaccuracies in the pose can introduce errors in the runtime animation. However, by including the perturbation of the virtual cameras in the generation of the training data, the learning algorithm can learn to adapt to inaccuracies in the placement of the real cameras. Perturbations may also include adding or removing a virtual camera. The generation of training data in this way results in a more robust learning algorithm. Typically, many thousands of perturbations may be generated, as the significant limiting factor is the computing time available for the generation of the perturbations.

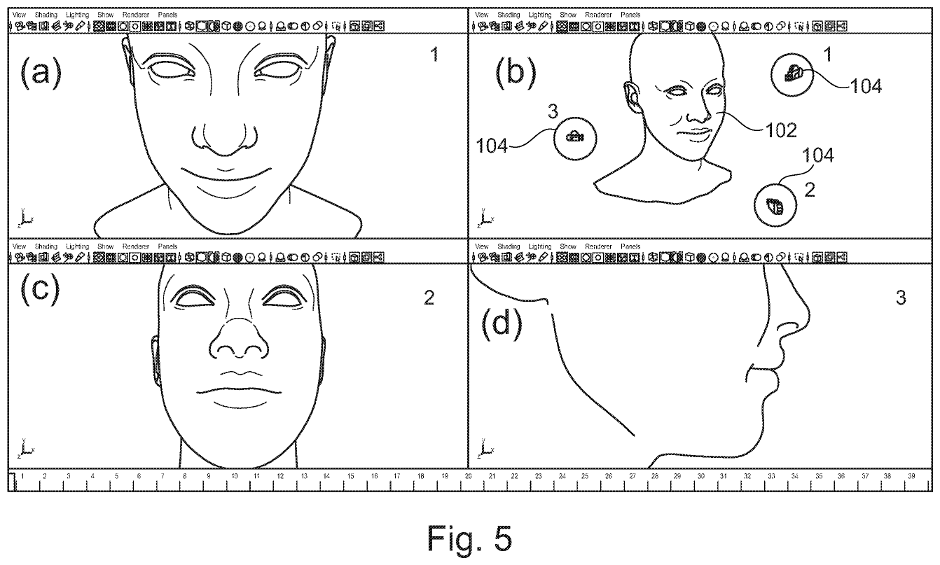

Referring now to FIGS. 5(a), (b), (c) and (d), there is shown an example of a model space 100 and 3D model 102. In FIG. 5(b), we can see the 3D model 502 with three virtual cameras 104 placed around it. FIG. 5(a) shows the view from virtual camera 1, FIG. 5(c) shows the view from virtual camera 2, and FIG. 5(c) shows the view from virtual camera 3.

Typically, the 3D model 102 may relate to a specific actor, but may also be a generic model of a human face or other deformable object where it is intended to create an animated object or character based on the deformation object. For the most accurate results at runtime, a “digital double” 3D model of the runtime deformable object is recommended, for example the runtime actor. If it was preferred to create a system that was not limited to a particular runtime deformable object, it is possible to create a more generic system by using a collection of 3D models of the class of deformable object. For example, in the case where the runtime actor has not yet been identified, a number of 3D models of human faces could be used to create the training data. However, if using a non-specific model, for accurate results at runtime, it is recommended to carry out a pre-processing step of identifying the base-offset between the fiducial points of the 3D model and the corresponding points on the actor's face, and compensating therefor. In cases where the animated object to be output at runtime is not a direct representation of the 3D model, for example, where the animated object is an animal whose facial expressions are to be animated based on those of an actor, it is also recommended to carry out some pre-processing steps. In many cases of human facial animation, there will be differing facial geometry between the runtime actor and the 3D model, but nonetheless the movement of both is expected to be broadly similar. In such cases, the base-offset is taken between the fiducial points on the 3D model and the corresponding points on the runtime actor. This base-offset is then applied at all stages of training, and during runtime application of any prediction system based on the training data.

Alignment is an optional step in both methods described above. It is a known technique that may be used to adjust captured images to counteract the effects of translation, rotation and scale due to movement of the cameras. In the present disclosure, only alignment in relation to translation and rotation are used. Alignment may be understood in greater detail by referring to the following paper “Least-squares estimation of transformation parameters between two point patterns” by Shinji Umeyama, as published in the IEE Transactions on Pattern Analysis and Machine Intelligence, Vol. 13, No. 4, April 1991, page 376-380.

Once a training data set has been created, it can be used to teach a learning algorithm to provide the correct output animation from the runtime input of the deformable object. However, it may be useful to carry out a review based on the algorithm trained on the training data set. It may be possible to improve the runtime performance by adjusting the training data set and re-teaching the learning algorithm. For example, the chosen method could be implemented again with more, fewer or different deformations. Additionally, or alternatively, the method could be run again with more, fewer or different perturbations; or by altering the alignments steps included.

In this way, the methods of the disclosure facilitate learning the relationship between a real object and a digital representation corresponding to that object.

A learning algorithm trained using synthetic training data created according to the methods of the disclosure may be used in the same way as a prior art learning algorithm to provide predicted animation values for an output animation, such as a digital character, corresponding to the object input data, such as an actor's performance.

The present invention relates to method of generating training data for use in animating an animated object corresponding to a deformable object. The method comprises accessing a 3D model of the deformable object, defining a plurality of virtual cameras directed at the 3D model; varying adjustable controls of the 3D model to create a set of deformations on the 3D model. Then, for each deformation, capturing 2D projections of points at each virtual camera, combining the projections to form a vector of 2D point coordinates, generating a vector of 2D shape parameters from the point coordinates, and combining the shape parameters with the values of the adjustable controls for that deformation to form a training data item. The training data items are combined to form a training data set for use in training a learning algorithm for use in animating an animated object corresponding to the deformable object based on real deformations. The method allows for the generation of large quantities of training data that would otherwise be very time-consuming to obtain from the deformable object.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of generating training data for use in animating an animated object corresponding to a deformable object, the method comprising
accessing a 3D model of the deformable object, wherein the 3D model is annotated with a plurality of fiducial points, which fiducial points correspond to features of the deformable object and are subject to adjustable controls which change the representation of the 3D model;
defining a plurality of virtual cameras in a model space, the cameras directed at the 3D model;
varying the adjustable controls of the 3D model to create a set of deformations on the 3D model;
for each deformation in the set of deformations,
capturing 2D projections of the plurality of fiducial points at each virtual camera,
combining the 2D projections from each camera to form a vector of 2D point coordinates,
using the vector of 2D point coordinates to generate a vector of 2D shape parameters derived from the 2D point coordinates, and
combining the 2D shape parameters with the corresponding values of the adjustable controls for that deformation to form a training data item; and
combining the training data items to form a training data set suitable for use in training a learning algorithm for use in animating an animated object corresponding to the deformable object based on real deformations of the deformable object captured by cameras whose poses correspond to those of the plurality of virtual cameras.

2. A method as claimed claim 1 in any preceding claim further comprising perturbing the pose of at least one of the virtual cameras for each deformation and capturing the 2D projections for each perturbed pose.

3. A method as claimed in claim 2 wherein the pose of a camera comprises its orientation and its location in the model space and wherein perturbing the pose of at least one camera comprises pseudo-randomly altering at least one aspect of the pose.

4. A method as claimed in claim 1 comprising aligning the 2D projections for each deformation.

5. A method as claimed in claim 4 comprising aligning the 2D projections for each deformation using at least one of a translation or rotational alignment.

6. A method as claimed in claim 1 wherein varying the adjustable controls of the 3D model comprises varying the adjustable controls to each of a set of predefined values.

7. A method as claimed in claim 1 wherein varying the adjustable controls of the 3D model comprises varying the adjustable controls in a stepwise manner.

8. A method as claimed in claim 1 wherein the deformable object is a face and the deformations correspond to facial expressions.

9. A method as claimed in claim 1 wherein the fiducial points correspond to natural facial features.

10. A method as claimed in claim 1 wherein the fiducial points comprise points marked on the actor's face.

11. A method as claimed in claim 1 wherein combining the 2D projections from each camera to form a vector of 2D point coordinates comprises concatenating the 2D projections from each camera.

12. A method as claimed in claim 1 comprising training the learning algorithm using the training data set by building a prediction model between 2D shape parameters and the known values of the adjustable controls.

13. A method as claimed in claim 12 comprising building the prediction model using a support vector machine.

14. A method as claimed in claim 12 comprising building the prediction model using a neural network.

15. A method as claimed in claim 12 comprising using the learning algorithm to animate an animated object corresponding to the deformable object based on real deformations of the deformable object captured by cameras whose poses correspond to those of the plurality of virtual cameras.

16. A method of generating training data for use in animating an animated object corresponding to a deformable object, the method comprising
accessing a 3D model of the deformable object, wherein the 3D model is annotated with a plurality of fiducial points, which fiducial points correspond to features of the deformable object and are subject to adjustable controls which change the representation of the 3D model;
defining a plurality of virtual cameras in a model space, the cameras directed at the 3D model;
varying the adjustable controls of the 3D model to create a set of deformations on the 3D model;
for each deformation in the set of deformations,
capturing 2D projections of the plurality of fiducial points at each virtual camera,
aligning the 2D projections,
combining the 2D projections from each camera to form a vector of 2D point coordinates,
using the vector of 2D point coordinates to generate a vector of 2D shape parameters derived from the 2D point coordinates, and
combining the 2D shape parameters with the corresponding values of the adjustable controls for that deformation to form a training data item; and
combining the training data items to form a training data set suitable for use in training a learning algorithm for use in animating an animated object corresponding to the deformable object based on real deformations of the deformable object captured by cameras whose poses correspond to those of the plurality of virtual cameras

17. A method as claimed in claim 16 comprising aligning the 2D projections for each deformation using at least one of a translation or rotational alignment.
